(19) United States
(12) Patent Application Publication
(10) Pub. No.: US 2022/0136753 A1
(43) Pub. Date: May 5, 2022

(54) HEAT PUMP DEVICE, HEAT PUMP SYSTEM, AIR CONDITIONER, AND REFRIGERATION MACHINE

(71) Applicant: Mitsubishi Electric Corporation, Tokyo (JP)

(72) Inventors: Takashi YAMAKAWA, Tokyo (JP); Keisuke UEMURA, Tokyo (JP)

(21) Appl. No.: 17/431,748

(22) PCT Filed: May 7, 2019
(86) PCT No.: PCT/JP2019/018302

§ 371 Date: Aug. 18, 2021

(51) Int. Cl. F25B 49/02; F04B 49/06; F04C 28/28; H02P 27/08

(52) U.S. Cl. CPC F25B 49/025; F04B 49/06; F04C 28/28; F04C 2270/701; F25B 2600/021; F04C 2240/403; H02P 27/08

(57) ABSTRACT

A heat pump device includes a compressor that compresses refrigerant, a motor that drives the compressor, an inverter that applies a desired voltage to the motor, and an inverter controlling unit that generates a pulse width modulation signal for driving the inverter, has, as operation modes, a heating operation mode performing heating operation of the compressor and a normal operation mode performing normal operation of the compressor to compress the refrigerant, and periodically changes carrier frequency, that is frequency of a carrier signal, in the heating operation mode.

### FIELD

The present invention relates to a heat pump device including a compressor, to a heat pump system, to an air conditioner, and to a refrigeration machine.

### BACKGROUND

Equipment including a compressor for compressing refrigerant has a function of causing current to flow to wires of a motor of the compressor to heat refrigerant when the refrigerant is in a state of stagnation so as to prevent the compressor from being broken by starting operation when the refrigerant accumulated in the compressor is in a state of stagnation. An example of the equipment including a compressor is a heat pump device. A heat pump device is applied to devices such as an air conditioner, a heat pump water heater, a refrigerator, and a freezer.

An air conditioner described in Patent Literature 1 applies, to a motor, a high-frequency voltage at a frequency higher than, that in the operation for compressing refrigerant when a state of stagnation of the refrigerant is detected, which prevents occurrence of rotation torque and vibration, and achieves efficient heating using iron loss and copper loss.

### CITATION LIST

### Patent Literature

Patent Literature 1: Japanese Patent Application Laid-open No. 2011-038689

### SUMMARY

### Technical Problem

According to the technology described in Patent Literature 1, however, when the impedance of the motor is high, the flowing current is small relative to the output voltage, and thus sufficient power cannot be supplied. In contrast, when the impedance is low, the flowing current is large relative to the output voltage, which is problematic in that, although power can be obtained with a small voltage, for example, the accuracy of voltage output is degraded and the direct-current voltages are superimposed owing to imbalance between positive and negative output voltages, thereby increasing the inverter loss, and the pulse width modulation (PVN) width of the inverter decreases due to the reduction of the output voltage, thereby causing narrow pulsed current to flow and thus increasing the inverter loss.

The present invention has been made in view of the above, and an object thereof is to provide a heat pump device capable of efficiently heating refrigerant stagnating in a compressor.

### Solution to Problem

To solve the aforementioned problems and achieve the object, a heat pump device according to the present invention includes: a compressor that compresses refrigerant; a motor that drives the compressor; and an inverter that applies a desired voltage to the motor. The heat pump device also includes: an inverter controlling unit that generates a pulse width modulation signal for driving the inverter, has, as operation modes, a heating operation mode for performing heating operation of the compressor and a normal operation mode for performing normal operation of the compressor to compress the refrigerant, and periodically changes a carrier frequency in the heating operation mode, the carrier frequency being a frequency of a carrier signal.

### Advantageous Effects of Invention

A heat pump device according to the present invention produces an effect of enabling efficient heating of refrigerant stagnating in a compressor.

### BRIEF DESCRIPTION OF DRAWINGS

FIG. 1 is a diagram illustrating an example of a configuration of a first embodiment of a heat pump device according to the present invention.

FIG. 2 is a diagram illustrating a configuration of an inverter according to the first embodiment.

FIG. 3 is a diagram illustrating an example of a configuration of a heating operation mode controlling unit and a driving signal generating unit of an inverter controlling unit according to the first embodiment.

FIG. 4 is a diagram illustrating an example of a configuration of a heating determining unit of the first embodiment.

FIG. 5 illustrates graphs of an example of the time variation of outside air temperature, compressor temperature, and a refrigerant stagnation amount.

FIG. 6 is a diagram illustrating an example of a configuration of a direct current applying unit.

FIG. 7 is a diagram illustrating an example of a configuration of a high-frequency current applying unit.

FIG. 8 is a table illustrating an example of eight switching patterns in the first embodiment.

FIG. 9 is a chart illustrating an example of operating waveforms when direct current application is selected by a current application switching unit.

FIG. 10 is a chart illustrating an example of operating waveforms when high-frequency current application is selected by the current application switching unit.

FIG. 11 is a diagram illustrating an example of a configuration of a high-frequency, current applying unit including a high-frequency phase switching unit.

FIG. 12 is a chart illustrating the operation of the inverter controlling unit according to the first embodiment.

FIG. 13 is an explanatory diagram of changes in voltage vectors illustrated in FIG. 12.

FIG. 14 is an explanatory diagram of a rotor position of an IPM motor.

FIG. 15 is a graph illustrating a change in current depending on the rotor position of the IPM motor.

FIG. 16 is a diagram illustrating applied voltage a case where θf is chanced with time.

FIG. 17 is a diagram illustrating an example of current flowing through each of U, V, and W phases of a motor when θf is 0°, 30°, and 60°.

FIG. 18 is a flowchart illustrating an example of the operation of the inverter controlling unit according to the first embodiment.

FIG. 19 is a graph illustrating an example of control of a carrier frequency performed by the inverter controlling unite, according to the first embodiment.

FIG. 20 is a graph illustrating another example of control of a carrier frequency performed by the inverter controlling unit according to the first embodiment.

FIG. 21 is a diagram illustrating an example of a configuration of a second embodiment of a heat pump device according to the present invention.

FIG. 22 is a Mollier diagram of the state of refrigerant in the heat pump device illustrated in FIG. 21.

### DESCRIPTION OF EMBODIMENTS

Embodiments of a heat pump device, a heat pump system, an air conditioner, and a refrigeration machine according to the present invention will be described detail below with reference to the drawings. Note that the present invention is not limited to the embodiments.

### First Embodiment

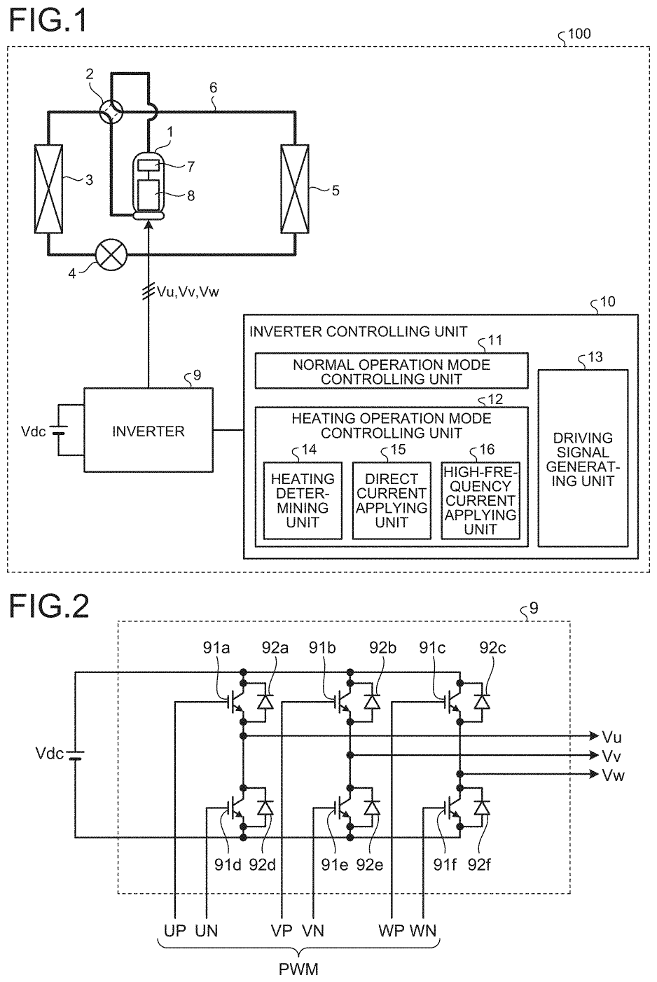

FIG. 1 is a diagram illustrating an example of a configuration of a first embodiment of a heat pump device according to the present invention. As illustrated in FIG. 1, a heat pump device 100 of the present embodiment includes a refrigeration cycle in which a compressor 1, a four-way valve 2, a heat exchanger 3, an expansion mechanism 4, and a heat exchanger 5 are connected in sequence via refrigerant piping 6. The compressor 1 includes therein a compression mechanism 7 for compressing refrigerant, and a motor 8 for causing the compression mechanism 7 to operate. The motor 8 is a three-phase motor having three-phase wires of U-phase, V-phase, and W-phase.

An inverter 9 for applying voltage to the motor 8 to drive the motor 8 is electrically connected with the motor 8. The inverter 9 uses a bus voltage Vdc, which is a direct-current voltage, as a power supply to apply voltages Vu, Vv, and Vw co the U-phase, V-phase, and U-phase wires of the motor 8, respectively.

In addition, an inverter controlling unit 10 is electrically connected with the inverter 9. The inverter controlling unit 10 includes a normal operation mode controlling unit 11 and a heating operation mode controlling unit 12, which are associated with two operation modes, i.e., a normal operation mode and a heating operation mode, respectively. In operation in the normal operation mode, the inverter controlling unit 10 controls the inverter 9 such that the motor 8 rotates. In operation in the heating operation mode, the inverter controlling unit 10 controls the inverter 9 such that the compressor is heated without rotating the motor 8. The inverter controlling unit 10 outputs a signal for driving the inverter 9, such as a PWM signal that is a pulse width modulation signal, to the inverter 9. Note that the inverter controlling unit 10 can be implemented by a discrete system such as a central processing unit (CPU), a digital signal processor (DSP), or a microcomputer. Alternatively, the inverter controlling unit 10 may be implemented by an electrical circuit element such as an analog circuit or a digital circuit.

The normal operation mode controlling unit 11 outputs PWM signals such that the inverter 9 rotates the motor 8. The heating operation mode controlling unit 12 includes a heating determining unit 14, a direct current applying unit 15, and a high-frequency current applying unit 16, so that, unlike the normal operation mode, a direct current or a high-frequency current that cannot be followed by the motor 8 is caused to flow in the motor 8 to perform heating without rotating the motor 8, and thus to heat liquid refrigerant stagnating in the compressor 1 to vaporize and discharge the liquid refrigerant.

FIG. 2 is a diagram illustrating a configuration of the inverter 9 according to the first embodiment. The inverter 9 is a circuit using the bus voltage Vdc as a power supply, and including three series-connections of two switching elements (91a and 91d, 91b and 91e, and 91c and 91f) connected in parallel, and freewheeling diodes 92a to 92f connected in parallel with the switching elements 91a to 91f, respectively. The inverter 9 drives the switching elements by PWM signals UP, VP, WP, UN, VN, and WN associated therewith and sent from the inverter controlling unit 10 (UP drives 91a, VP drives 91b, WP drives 91c, UN drives 91d, VN drives 91e, and WN drives 91f) to generate three-phase voltages Vu, Vv, and Vw, and applies the three-phase voltages Vu, Vv, and Vw to the U-phase, V-phase, and W-phase wires of the motor 8, respectively.

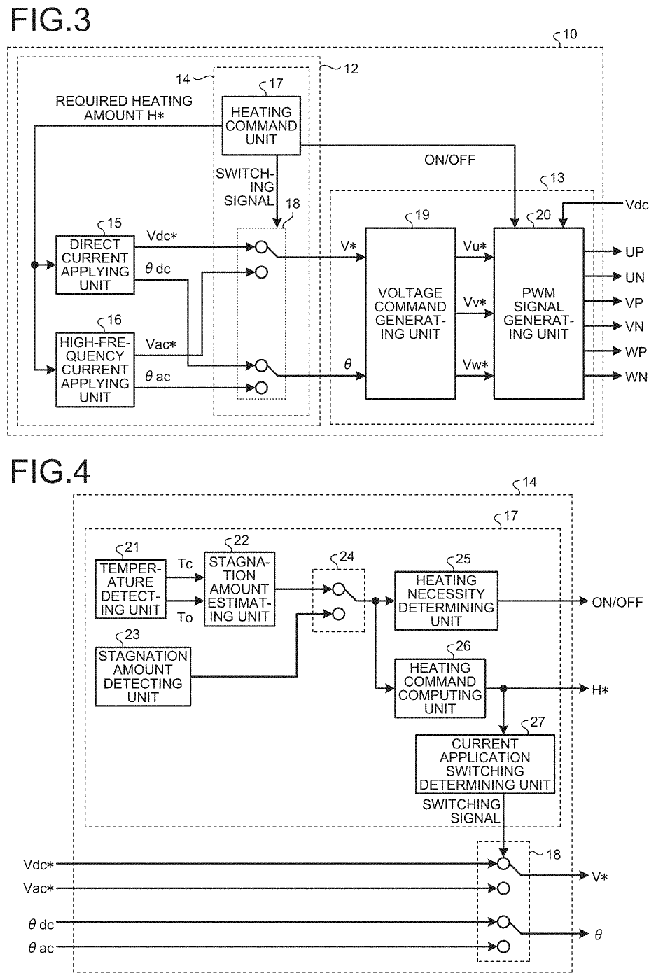

FIG. 3 is a diagram illustrating an example of a configuration of the heating operation mode controlling unit 12 and a driving signal generating unit 13 of the inverter controlling unit 10 according to the first embodiment. The inverter controlling unit 10 includes the heating operation mode controlling unit 12 and the driving signal generating unit 13.

The heating operation mode controlling unit 12 includes the heating determining unit 14, the direct current applying unit 15, and the high-frequency, current applying unit 16. The heating determining unit 14 includes a heating command unit 17 and a current application switching unit 18. The heating command unit 17 obtains a required heating amount H* necessary for forcing out stagnating refrigerant. The direct current applying unit 15 generates a direct-current voltage command Vdc* and a direct-current phase command θdc on the basis of the required heating amount H*. The high-frequency current applying unit 16 generates a high-frequency voltage command Vac* and a high-frequency phase command θac for generating high-frequency alternating-current voltage on the basis of the required heating amount H*. In addition, the heating command unit 17 sends a switching signal to the current application switching unit 18 to control selection of either Vdc* and θdc or Vac* and θac and transmission of a signal as a voltage command V* and a phase command θ to the driving signal generating unit 13.

The driving signal generating unit 13 includes a voltage command generating unit 19 and a PWM signal generating unit 20, The voltage command generating unit 19 generates three-phase (U-phase, V-phase, and h-phase) voltage commands Vu*, Vv*, and Vw* on the basis of the voltage command V* and the phase command θ. The PWM signal generating unit 20 generates PWM signals cup, VP, NP, UN, VN, and WN) for driving the inverter 9 on the basis of the three-phase voltage commands Vu*, Vv*, and VW* and the bus voltage Vdc to apply voltage to the motor 8 and heat the compressor 1.

Next, details of the heating determining unit 14 will be described with reference to FIG. 4. FIG. 4 is a diagram illustrating an example of a configuration of the heating determining unit 14 according to the first embodiment. The heating determining unit 14 includes the heating command unit 17 and the current application switching unit 18, and the heating command unit 17 includes a temperature detecting unit 21, a stagnation amount estimating unit 22, a stagnation amount detecting unit 23, a stagnation determination switching unit 24, a heating necessity determining unit 25, a heating command computing unit 26, and a current application switching determining unit 27.

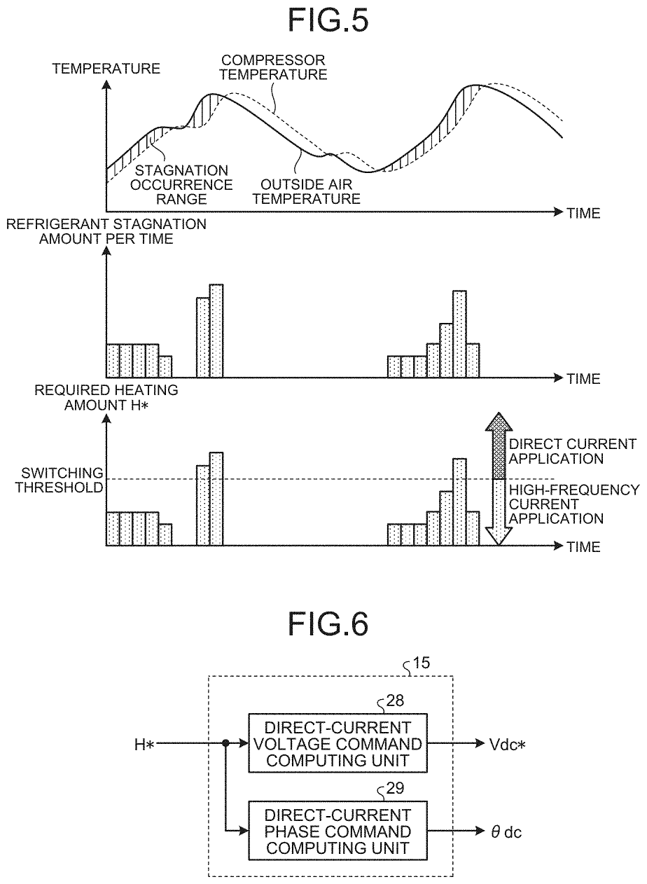

The temperature detecting unit 21 detects outside air temperature (Tc) and the temperature (To) of the compressor 1. The stagnation amount estimating unit 22 estimates the amount of liquid refrigerant stagnating in the compressor 1 on the basis of the outside air temperature and the temperature of the compressor 1 (compressor temperature). Note that, because the compressor 1 has the largest heat capacity in the refrigeration cycle and the compressor temperature rises after a delay from when the outside air temperature rises, the compressor 1 has the lowest temperature in the refrigeration cycle. Thus, the temperature relation is as illustrated in FIG. 5. FIG. 5 illustrates graphs of an example of the time variation of the outside air temperature, the compressor temperature, and the refrigerant stagnation amount.

As illustrated in FIG. 5, because the refrigerant stagnates at a position at the lowest temperature in the refrigeration cycle and is accumulated as liquid refrigerant, refrigerant is accumulated in the compressor 1 when the compressor temperature rises (stagnation occurrence ranges in FIG. 5). Thus, the stagnation amount estimating unit 22 can estimate a refrigerant stagnation amount per time from the relation between the outside air temperature and the compressor temperature that is obtained experimentally, for example. For example, the stagnation amount is estimated on the basis of a difference between the outside air temperature and the compressor temperature or an amount of change in the compressor temperature from the start of heating. Note that, even when only the outside air temperature is detected, if the heat capacity of the compressor 1 is known, a lag with which the compressor temperature changes after the outside air temperature changes can be estimated. Thus, a configuration to detect the outside air temperature without detecting the temperature of the compressor 1 can be used to reduce the number of sensors and thus reduce the cost. In addition, it is needless to say that similar estimation is possible by detecting the temperature of a component included in the refrigeration cycle, which is typified by the heat exchanger 3.

In addition, a more accurate stagnation amount can be obtained by providing a sensor for detecting the stagnation amount as the stagnation amount detecting unit 23 and directly detecting the stagnation amount of refrigerant. Note that examples of the sensor for detecting the stagnation amount include a capacitive sensor for measuring a fluid volume, and a sensor for measuring the distance between the upper part of the compressor 1 and a refrigerant level by laser, sound, electromagnetic waves, or the like. Note that either one of the outputs from the stagnation amount estimating unit 22 and the stagnation amount detecting unit 23 may be selected by the stagnation determination switching unit 24, or there would of course be no problem in using both of the stagnation amounts for control.

Upon determining that heating is necessary on the basis of the stagnation amount that is an output from the stagnation determination switching unit 24, the heating necessity determining unit 25 outputs an ON signal (indicating that heating operation is to be performed), and upon determining that heating is not necessary, the heating necessity determining unit 25 outputs an OFF signal (indicating that heating operation is not to be performed). In addition, the heating command computing unit 26 computes a required heating amount H* indicating the heating amount necessary for forcing out stagnating refrigerant depending on the stagnation amount. The required heating amount H* varies depending on the type and the size of the compressor 1, and when the compressor 1 is large or has a material or shape that is hard to transmit heat, the required heating amount H* is set to be high to enable liquid refrigerant to be reliably discharged. In addition, the current application switching determining unit 27 switches the current application method by outputting, to the current application switching unit 18, a signal for switching to direct current application when the required heating amount H* is equal to or larger than a predetermined switching threshold, and outputting, to the current application switching unit 18, a signal for switching to high-frequency current application when the required heating amount H* is smaller than the switching threshold.

Next, the direct current applying unit 15 will be described with reference to FIG. 6. FIG. 6 is a diagram illustrating an example of a configuration of the direct current applying unit 15. The direct current applying unit 15 includes a direct-current voltage command computing unit 28 and a direct-current phase command computing unit 29. The direct-car rent voltage command computing unit 28 outputs a direct-current voltage command Vdc* necessary for heat generation on the basis of the required heating amount H*. The direct-current voltage command computing unit 28 can store in advance the relation between the rewired heating amount H* and the direct-current voltage command Vdc* as table data, for example, and obtain the direct-current voltage command Vdc* therefrom. While the required heating amount H* is the input in the description, it is needless to say that a more correct value can be obtained by calculating the direct-current voltage command Vdc* by further using various data such as outside air temperature, compressor temperature, and compressor structure information as input, which can improve reliability.

In addition, the direct-current phase command computing unit 29 obtains a direct-current phase command θdc for applying current to the motor 8. θdc is a fixed value to apply a direct-current voltage. For example, for applying current to the motor 8 at a position of 0°, θdc=0 is output. When current is constantly applied at a fixed value, however, heat may be produced only at a specific part of the motor 8. Thus, θdc is changed with time, so that the motor 8 can be uniformly heated.

Note that, in the case of direct current application, because the compressor 1 can be heated by heat generation due to copper loss proportional to the resistance R of the wires of the motor 8 and the direct current Idc caused to flow in the motor 8, driving the inverter 9 such that the direct current Idc is increased enables a large amount of heat generation to be achieved, and enables liquefied refrigerant to be discharged in a short time. The resistance R of wires of recent motors 8, however, tends to be smaller because of high-efficiency design thereof; therefore, Idc needs to be increased by an amount corresponding to the amount of reduction of the resistance R in order to achieve the same heat generation amount. As a result, there is not only a concern about heat generation of the inverter 9 due to deterioration in the loss because current flowing in the inverter 9 is larger, but also a difficulty in direct current application for a long time because power consumption also increases.

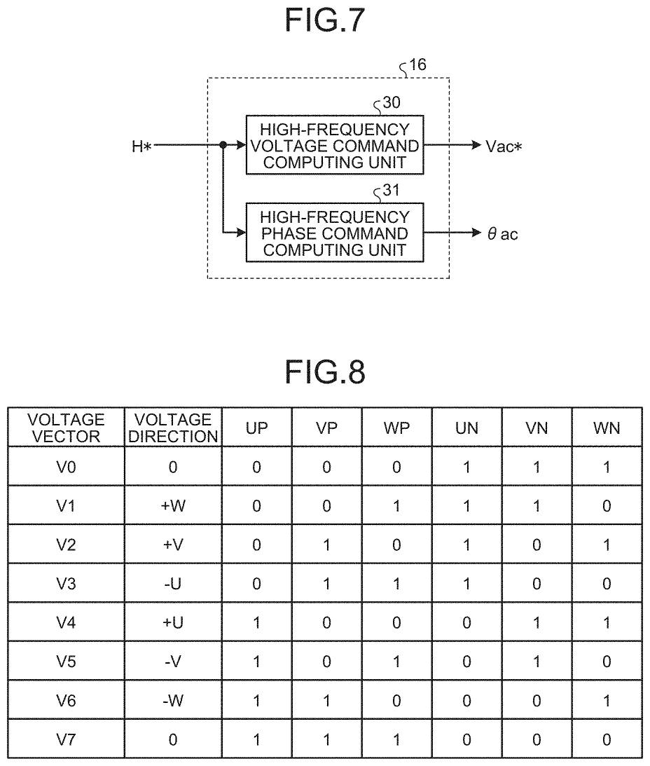

Next, the high-frequency current applying unit 16 will be described with reference to FIG. 7. FIG. 7 is a diagram illustrating an example of a configuration of the high-frequency current applying unit 16. The high-frequency current applying unit 16 includes a high-frequency voltage command computing unit 30 and a high-frequency phase command computing unit 31. The high-frequency voltage command computing unit 30 outputs a high-frequency voltage command Vac* necessary for heat generation on the basis of the required heating amount H*. The high-frequency voltage command computing unit 30 can store in advance the relation between the required heating amount H* and the high-frequency voltage command Vac* as table data, for example, and obtain the high-frequency voltage command Vac* therefrom. While the required heating amount H* is the input in the description, it is needless to say that a more correct value can be obtained by calculating the high-frequency voltage command Vac* from various data such as outside air temperature, compressor temperature, and compressor structure information, which can improve reliability.

In addition, the high-frequency phase command computing unit 31 obtains a high-frequency phase command Sac for applying current to the motor 8. In order to apply high-frequency, voltage, θac is continuously changed in a range from 0° to 360° with respect to time, so that high-frequency voltage is generated. Note that as the period of change in the range from 0° to 360° is made to be shorter, the frequency of the high-frequency voltage can be increased.

In the case of high-frequency current application, in contrast to direct current application, high-frequency current Ica is caused to flow in the motor 8 by the inverter 9, so that the motor 8 can be heated by causing iron loss such as eddy current loss or hysteresis loss to occur in a magnetic material that is a material of a stator or a rotor of the motor 8. In addition, when angular frequency u of the high-frequency current is high, it is possible to not only increase the amount heat generation by the increase in iron loss but also increase the impedance by the inductance L of the motor 8 and also reduce the high-frequency current Iac flowing therein. This enables heating of the motor 8 while reducing the loss of the inverter 9; therefore, it possible to save energy and contribute to prevention of local warming. When high-frequency current application is performed, however, unwanted sound that is electromagnetic noise of the motor 8 occurs; therefore, the frequency need to be brought close to 20 kHz, which is audio frequency. There is therefore a problem in that a required heating amount cannot be obtained when a small motor with small iron loss or a motor with large inductance is used.

Thus, in the present embodiment, when the required heating amount H* is large, direct current application is performed to increase the heating amount, which enables liquid refrigerant to be discharged in a short time. When the required heating amount H* is small, high-frequency current application is performed to perform heating with reduced power consumption, which not only enables liquid refrigerant to be reliably discharged and improves reliability, but also enables operation with reduced power consumption contributing to prevention of global warming. Thus, the current application switching determining unit 27 is configured to switch to direct current application by the current application switching unit 18 when the required heating amount H* is equal to or larger than the switching threshold and switch to high-frequency current application by the current application switching unit 18 when the required heating amount H* is smaller than the switching threshold to obtain the voltage command V* and the phase command 8, thus enabling the effects described above to be produced.

The method for obtaining the voltage command V* and the phase command θ has been described above, and a method for generating the voltage commands VU*, Vv*, and Vw* by the voltage command generating unit 19 and a method for generating a PWM signal by the PWM signal generating unit 20 will therefore be described next.

When the motor 8 is a three-phase motor, the U, V, and W phases typically differ from each other by 120°(=2π/3). Thus, the voltage commands Vu*, VV*, and VW* are defined. as cosine waves (sine waves) with phases differing from each other by 2π/3 as in the following formulas (1) to (3).

Vu*−V*×cos θ (1)

Vv*−V*×cos(θ−(2/3)π) (2)

Vw*−V*×cos(θ+(2/3)π) (3)

The voltage command generating unit 19 calculates voltage commands Vu*, Vv*, and Vw* by the formulas (1) to (3) on the basis of the voltage command V* and the phase command θ, and outputs the calculated voltage commands Vu*, Vv*, and VW* to the PWM signal generating unit 20. The PWM signal generating unit 20 compares the voltage commands Vu*, VV*, and Vw* with a carrier signal (reference signal) having an amplitude of Vdc/2 at a predetermined frequency, and generates PWM signals UP, VP, WP, UN, VP, and WN on the basis of the relation of magnitudes thereof.

While the voltage commands Vu*, Vv*, and Vw* are obtained by simple trigonometric functions in the formulas (1) to (3), other methods for obtaining the voltage commands Vu*, Vv*, and Vw* such as two-phase modulation, third-harmonic superposition modulation, and space vector modulation may be used with no problem.

Note that, when the voltage command Vu* is larger than the carrier signal, UP is a voltage for turning the switching element 91a ON, and UN is a voltage for turning the switching element 91d OFF. Conversely, when the voltage command Vu* is smaller than the carrier signal, UP is a voltage for turning the switching element 91a OFF, and UN is a voltage for turning the switching element 91d ON. The same is applicable to other signals, that is, VP and VU are determined by comparison between the voltage command Vv* and the carrier signal, and NP and WN are determined by comparison between the voltage command Vw* and the carrier signal.

In a case of a typical inverter, because a complementary PWM method is used, UP and UN, VP and VN, and WP and NN each have an inverse relationship to each other. Thus, there are a total of eight switching patterns.

FIG. 8 is a table illustrating an example of the eight switching patterns in the first embodiment. Note that, in FIG. 8, voltage vectors generated in respective switching patterns are represented by references V0 to V7. In addition, voltage directions of the respective voltage vectors are represented by ±U, ±7, and ±W (0 when no voltage is generated). Note that °U refers to a voltage that generates a current in the U-phase direction that flows into the motor 8 via the U phase and flows out from the motor 8 via the V phase and the N phase, and −U refers to a voltage that generates a car rent in the −U-phase direction that flows into the motor 8 via the V phase and the W phase and flows out from the motor 8 via the U phase. ±V and ±W similarly refer to directions in individual phases.

Voltage vectors are output by combining the switching patterns illustrated in FIG. 8, and a desired voltage can thus be output to the inverter 9. When the compressor 1 is operated to compress refrigerant by the motor 8 (normal operation mode), the operation is typically performed at several tens to several kHz or lower. When the applied voltage in the normal operation mode is at several tens to several kHz, direct-current voltage can be generated by setting the phase θ to a fixed value to heat the compressor 1 or high-frequency voltage (high-frequency alternating-current voltage) exceeding several kHz can be output by changing the phase θ at a high rate to apply current to the compressor 1 and heat the compressor 1, in the heating operation mode. Note that the high-frequency voltage may be applied to three phases or to two phases.

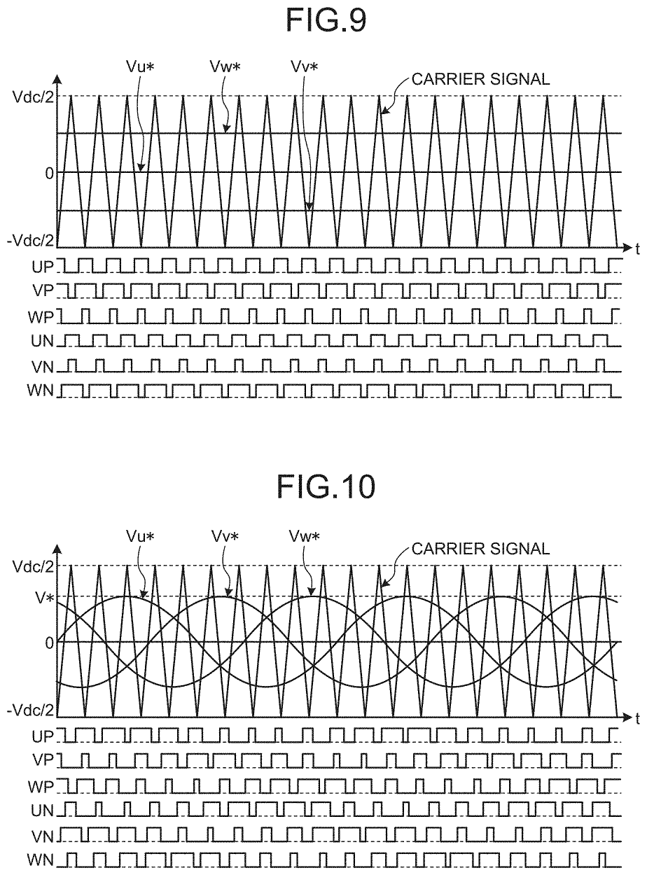

FIG. 9 is a chart illustrating an example of operating waveforms when the direct current application is selected by the current application switching unit 18. When θ=90° is set, Vu*=0, Vv*=0.5 V*, and Vw*=0.5 V* are obtained, PWM signals illustrated in FIG. 9 are obtained as a result of comparison with the carrier signal (reference signal), voltage vectors V0 (0 voltage), V2 (+V voltage), V6 (−W voltage) , and V7 (0 voltage) in FIG. 8 are output, and direct current can thus be caused to flow in the motor 8.

FIG. 10 is a chart illustrating an example of operating waveforms when the high-frequency current application is selected by the current application switching unit 18. Because θ=0° to 360° is set, Vu*, Vv*, and Vw* are sine waves (cosine waves) with a phase difference of 120°, PWM signals illustrated in FIG. 10 are obtained as a result of comparison with the carrier signal (reference signal), the voltage vectors change with time, and high-frequency current can thus be caused to flow in the motor 8.

In a case of a typical inverter, however, an upper limit of a carrier frequency, which is the frequency of the carrier signal, is determined by the switching speeds of switching elements of the inverter. It is therefore difficult to output high-frequency voltage at a frequency equal to or higher than the, carrier frequency. Note that, in a case of a typical insulated gate bipolar transistor (IGHT), the upper limit of the switching speed is about 20 kHz.

When the frequency of high-frequency voltage is about 1/10 of the carrier frequency, the accuracy of output of the waveform of the high-frequency voltage may be degraded, which may have an adverse effect such as superimposition of direct-current components. In view of this, in a case when the carrier frequency is 20 kHz, if the frequency of high-frequency voltage is set to be equal to or lower than 2 KHz, which is 1/10 of the carrier frequency, the frequency of the high-frequency voltage is within an audio frequency range, and unwanted sound may become worse.

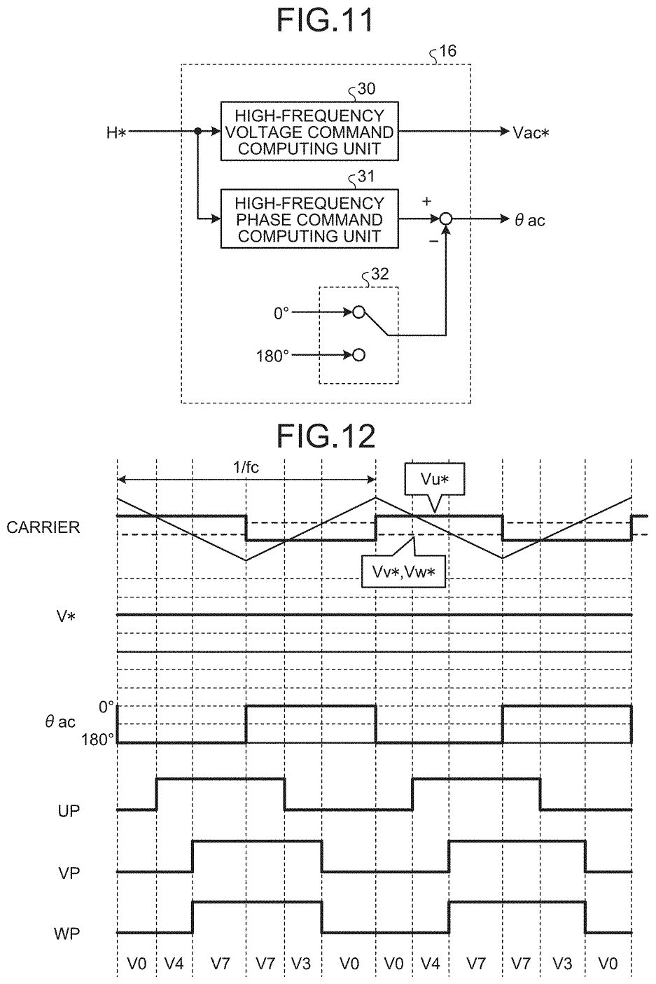

Thus, the high-frequency current applying unit 16 may be configured to add an output from a high-frequency phase switching unit 32, which switches the output between 0° and 180°, to an output from the high-frequency phase command computing unit 31, and output the result of addition as a high-frequency phase command θac as illustrated in FIG. 11. FIG. 11 is a diagram illustrating an example of a configuration of such a high-frequency current applying unit 16. In the example of the configuration in FIG. 11, the high-frequency phase command computing unit 31 outputs a fixed value to output only the phase of the motor 8 in which current is to be applied. The high-frequency phase switching unit 32 switches between 0° and 180° at the timings of peaks or valleys of the carrier signal to output positive and negative voltages in synchronization with the carrier signal, which enables voltage output at a frequency equivalent to the carrier frequency.

FIG. 12 is a chart illustrating the operation of the inverter controlling unit 10. FIG. 12 illustrates the operation of the inverter controlling unit 10 when the voltage command V* is a given value and the output of the high-frequency phase command computing unit 31 is 0°. The high-frequency phase command θac is switched between 0° and 180° at the timings of the peaks, the valleys, or the peaks and the valleys of the carrier signal, which enables PWM signals to be output in synchronization with the carrier signal. In this case, the voltage vectors change in an order of V0 (UP=VP=WP=0), V4 (U=1, VP−WP−0), V7 (UP=VP=WP=1), V3 (UP=0, VP=WP=1), V0 (UP=VP=WP=0), . . . .

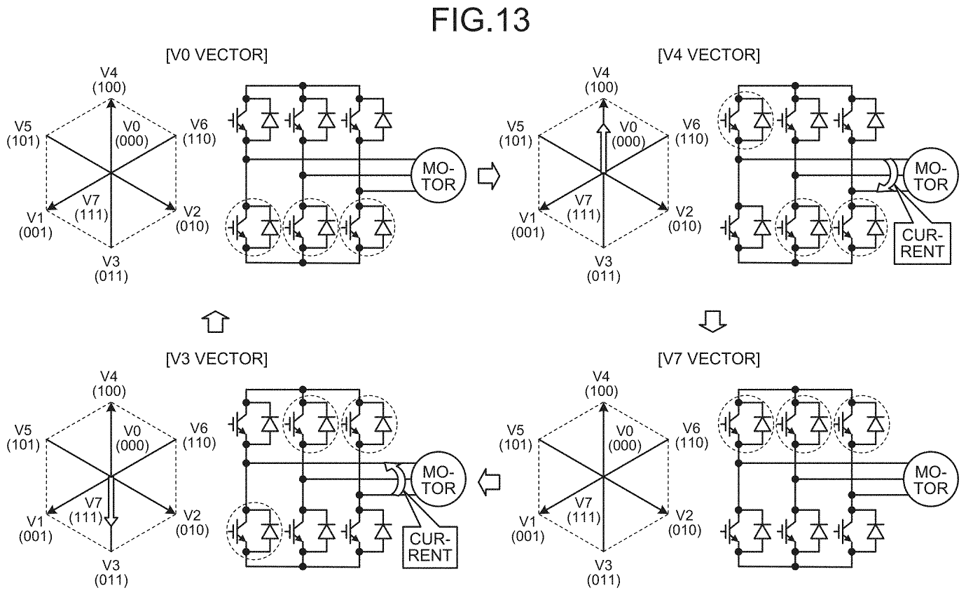

FIG. 13 is an explanatory diagram of changes in the voltage vectors illustrated in FIG. 12. Note that, in FIG. 13, switching elements 91 in dash circles are ON, and switching elements 91 that are not in dash circles are OFF. As illustrated in FIG. 13, at the time of application of a V0 vector and a V7 vector, the wires of the motor 8 are short-circuited, and no voltage is output. In this case, energy accumulated in the inductance of the motor 8 flows as current through the short circuit. At the time of application of a VA vector, a current in the U-phase direction (a current of +Iu) flows into the motor 8 through the U phase and flows out from the motor 8 through the V phase and the W phase, and at the time of application of a V3 vector, a current in the −U-phase direction (a current of −Iu) flows into the motor 8 via the V phase and the W phase and flows out from the motor 8 via the U phase, through the wires of the motor 8. Thus, currents flow through the wires of the motor 8 in opposite directions at the time of application of the V4 vector and at the time of application of the V3 vector. Because the voltage vectors change in the order of V0, V4, V7, V3, V0, . . . , the current of +Iu and the current of −Iu flow alternately through the wires of the motor 8. In particular, as illustrated in FIG. 12, because the V4 vector and the V3 vector appear within one carrier period (1/fc), an alternating-current voltage in synchronization with the carrier frequency fc can be applied to the wires of the motor 8.

In addition, because the V4 vector (current of +Iu) and the V3 vector (current of −Iu) are alternately output, forward and reverse torques are instantly switched therebetween. The torque is thus canceled out, which enables application of voltage with reduced rotor vibration.

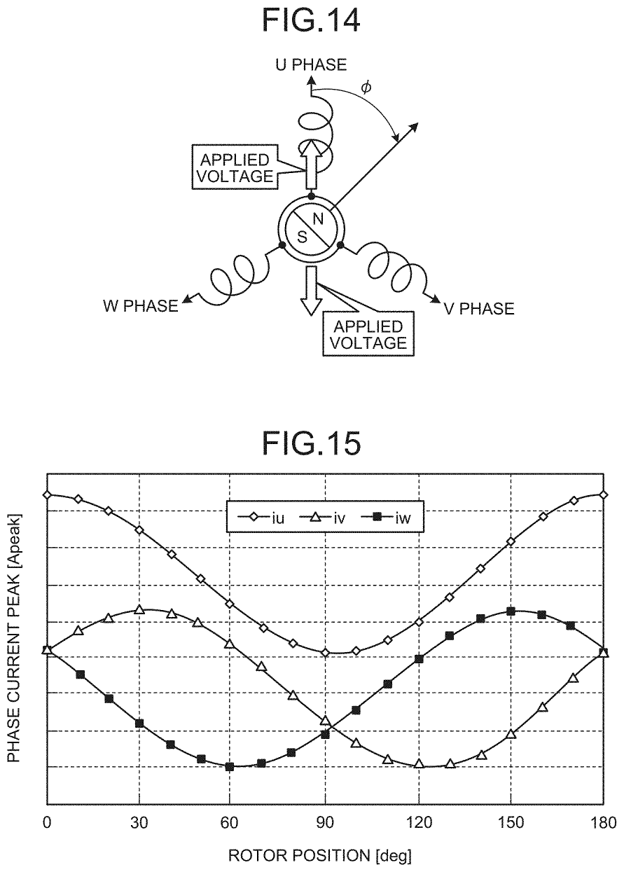

FIG. 14 is an explanatory diagram of a rotor position (rotor stop position) of an interior permanent magnet (IPM) motor, Herein, the rotor position φ of the 1PM motor is expressed by the magnitude of an angle by which the direction of the N pole of the rotor is deviated from the U-phase direction.

FIG. 15 is a graph illustrating a change in current depending on the rotor position of an IPM motor. In a case where the motor 8 is an IPM motor, winding inductance depends on the rotor position. Thus, winding impedance expressed by a product of the electric angular frequency ω and an inductance value varies depending on the rotor position. Thus, even when the same voltage is applied, current flowing through the wires of the motor 8 varies depending on the rotor position, and the heating amount changes. As a result, depending on the rotor position, much power may be consumed in order to obtain the required heating amount.

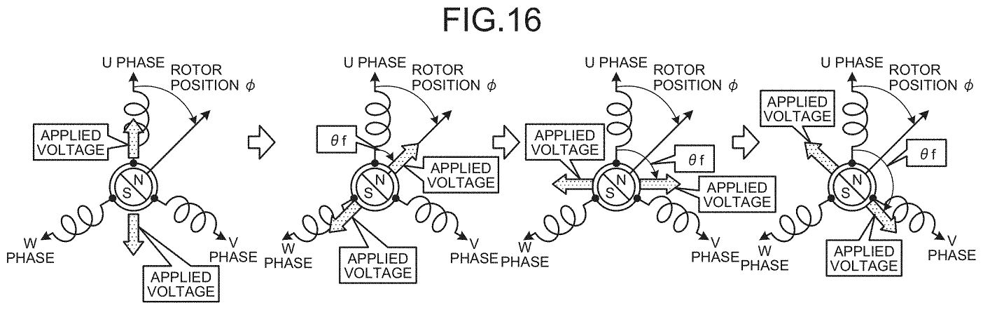

In the present embodiment, the output (represented by θf) of the high-frequency phase command computing unit 31 is therefore changed with time, so that voltage is uniformly applied to the rotor. FIG. 16 is a diagram illustrating applied voltage in a case where θf is changed with time. Herein, θf is changed by 45° with time in an order of 0°, 45°, 90°, 135°, . . . . When θf is 0°, the phase θ of the voltage command is 0° and 180°, when θf is 45′, the phase θ of the voltage command is 45° and 225°, when θf is 90°, the phase θ of the voltage command is 90° and 270°, and when θf is 135°, the phase θ of the voltage command is 135° and 315°.

Specifically, θf is initially set to 0°, and the phase θ of the voltage command is switched between 0° and 180° in synchronization with the carrier signal for a predetermined time. Thereafter, Of is switched to 45°, and the phase θ of the voltage command is switched between 45° and 225° in synchronization with the carrier signal for a predetermined time. Thereafter, θf is switched to 90° . . . , and in this manner, the phase of the voltage command is switched between 0° and 180°, between 45 and 225°, between 90° and 270°, between 135° and 315°, . . . at every predetermined time. Because the current application phase of the high-frequency alternating-current voltage changes with time in this manner, the influence of the inductance characteristics depending on the rotor stop position can be eliminated, and the compressor 1 can be uniformly heated independently of the rotor position.

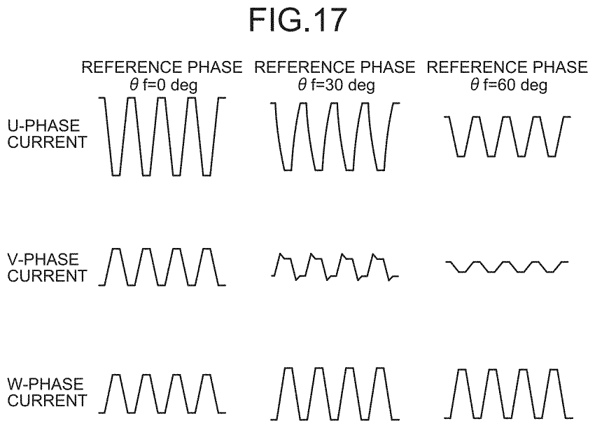

FIG. 17 is a diagram illustrating an example of current flowing through each of the U, V, and W phases of the motor 8 when θf is 0° (the U-phase (V4) direction is 0°), 30° , and 60°. When θf is 0°, only one other voltage vector (voltage vector with which one switching element on the positive voltage side and two switching elements on the negative voltage side or two switching elements on the positive voltage side and one switching element on the negative voltage side are ON among the switching elements 91a to 91f) is generated between V0 and V7 as illustrated in FIG. 17. In this case, the current has a trapezoidal waveform with less harmonic components.

When θf is 30°, however, two different voltage vectors are generated between V0 and V7. In this case, the current has a deformed waveform with much harmonic components. The deformation in the current waveform may have an adverse effect such as unwanted motor sound or motor shaft vibration.

When θf is 60° as well, in a manner similar to the case where θf is 0°, only one other voltage vector is generated between V0 and V7. In this case, the current has a trapezoidal waveform with less harmonic components.

As described above, when the reference phase θf is n times 60° (n is an integer equal to or larger than 0), the phase θ of the voltage command is a multiple of 60° (herein, θp=0°, θn=180°) and thus only one other voltage vector is generated between V0 and V7. In contrast, when the reference phase θf is other than n times 60°, the phase θ of the voltage command is not a multiple of 60° and two other voltage vectors are thus generated between V0 and V7. When two other voltage vectors are generated between V0 and V7, the current has a deformed waveform with more harmonic components, which may have an adverse effect such as unwanted motor sound and motor shaft vibration. It is therefore desirable to change the reference phase θf in increments of n times 60° in such a manner as 0°, 60°, . . . .

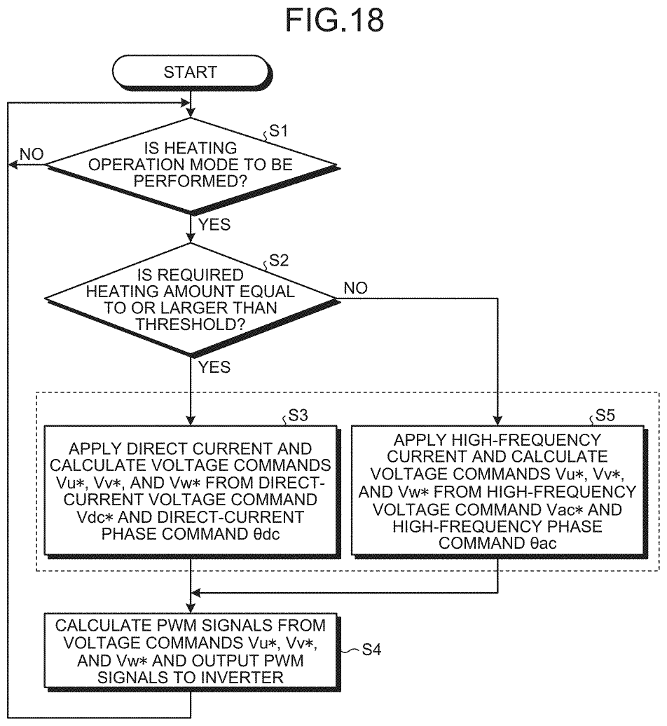

Next, the operation of the inverter controlling unit 10 will be described. FIG. 18 is a flowchart illustrating an example of the operation of the inverter controlling unit 10 according to the first embodiment. While the operation of the compressor 1 is stopped, the heating determining unit 14 determines whether or not to perform the heating operation mode by the operation described above (step S1: heating determination step).

If the heating necessity determining unit 25 has determined to perform the heating operation mode (step S1 Yes), a not indicating a heating mode is provided as operation mode information.

Subsequently, it is determined whether or not the required heating amount H*, which is an output from the heating command computing unit 26, is equal to or larger than the threshold (step S2: current application switching step), and if the required heating amount H* is equal to or larger than the threshold (step S2 Yes), the current application switching unit 18 switches to the direct current application to set Vdc* and θdc as V* and θ, and the voltage command generating unit 19 calculates the voltage commands Vu*, Vv*, and Vw* (step S3). The PWM signal generating unit 20 then compares the voltage commands Vu*, Vv*, and Vw* output by the voltage command generating unit 19 with the carrier signal, and obtains and outputs the PWM signals UP, VP, WP, UN, VN, and WN to the inverter 9 (step S4) , and then the operation returns to step S1.

If the heating necessity determining unit 25 has determined not co perform the heating operation mode in step S1 (step S1 No), the operation returns to step S1, in which it is determined again after a predetermined time whether or not to perform the heating operation mode.

If it is determined in step S2 that the required heating amount H* is smaller than the threshold (step S2 No), the current application switching unit 18 switches to the high-frequency current application to set Vac* and θac as V* and θ, the, voltage command generating unit 19 calculates the voltage commands Vu*, Vv*, and Vw* (step S5), and the operation proceeds to step S4.

Through the operation described above, in the heating operation mode, the switching elements 91a to 91f of the inverter 9 are driven to cause direct current or high-frequency current to flow in the motor 8. When the direct current application is selected, the motor 8 can generate heat by copper loss caused by direct current, and supply high power. Thus, the motor 8 can be heated in a short time, which enables liquid refrigerant stagnating in the compressor 1 to be heated and vaporized, and leaked to the outside of the compressor 1 in a short time. When the high-frequency, current application is selected, the motor 8 can be efficiently heated by not only iron loss due to the high-frequency current but also copper loss due to current flowing through the wires. Thus, the motor 8 can be heated with minimum power consumption, and liquid refrigerant stagnating in the compressor 1 can be heated and vaporized, and leaked to the outside of the compressor 1.

As described above, in the heat pump device 100 according to the present embodiment, when liquid refrigerant is in a state of stagnation in the compressor 1, current at a frequency out of an audio frequency range is caused to flow in the motor 8 by direct current application or high-frequency current application to reduce unwanted sound, and the current application is switched as necessary to direct current application when the required heating amount is large and to high-frequency current application that is highly efficient when the required heating amount is small, which enables the motor 8 to be heated efficiently. As a result, refrigerant stagnating in the compressor 1 can be efficiently heated and the stagnating refrigerant can be leaked to the outside of the compressor 1.

In the case of the direct current application, direct current flows in the motor 8 and the rotor of the motor 8 can be fixed to a predetermined position by direct-current excitation; therefore, the rotor does not rotate or vibrate.

Note that, when a high-frequency voltage equal to or higher than the operation frequency during compressing operation is applied to the motor 8 at the time of high-frequency current application, the rotor in the motor 8 cannot follow the frequency and thus rotation and vibration do not occur. Thus, the frequency of voltage output by the inverter 9 is desirably equal to or higher than the operation frequency during compressing operation.

Typically, the operation frequency during compressing operation is at most 1 kHz. Thus, it is sufficient if a high-frequency voltage equal to or higher than 1 kHz is applied to the motor 8. When a high-frequency voltage equal to or higher than 14 kHz is applied to the motor 8, the vibration sound of an iron core of the motor 8 is almost close to the upper limit of audio frequency, which also produces an advantageous effect in reducing unwanted sound. Thus, a high-frequency voltage of about 20 kHz outside of an audio frequency range is output, for example.

If, however, the frequency of the high-frequency voltage exceeds a maximum rated frequency of the switching elements 91a to 91f, a load or a power source short circuit may be caused by breakage of the switching elements 91a to 91f, which may lead to smoke and fire. The frequency of the high-frequency voltage is therefore desirably equal to or lower than the maximum rated frequency so that reliability is ensured.

In addition, for the motor 8 of the compressor 1 for a recent heat pump device, a motor having an IPM structure for increasing the efficiency or a concentrated winding motor with small coil ends and a low coil resistance has been widely used. Because a concentrated winding motor has a low coil resistance and generates a small amount of heat by copper loss, a large amount of current needs to flow in the wires. When a large amount of current flows in the wires, the amount of current flowing in the inverter 9 also becomes large, which increases the inverter loss.

Thus, normally, when heating is performed by high-frequency, current application in the heating operation mode, the inductance components are increased due to high frequency, and the winding impedance increases. As a result, the current flowing in the wires becomes smaller and the copper loss is reduced; however, iron loss is caused by application of the high-frequency voltage accordingly, which enables effective heating. Furthermore, because the current flowing in the wires becomes smaller, the current flowing in the inverter 9 also becomes smaller, which also reduces the loss in the inverter 9 and enables more efficient heating.

In addition, when the compressor 1 is a motor having an 1PM structure, the rotor surface on which high-frequency magnetic fluxes interlink with each other also becomes a heat generating part as a result of heating by high-frequency current application as described above. Thus, the area in contact with the refrigerant increases and quick heating of the compression mechanism is achieved, which enables the refrigerant to be efficiently heated. In the case of high-frequency current application, however, because a required heating amount is less likely, to be obtained when the impedance is too high, the high-frequency current application is switched to direct current application when a large heating amount is required, which enables liquid refrigerant stagnating in the compressor 1 to be reliably vaporized and leaked to the outside of the compressor 1.

As an alternative to switching between direct current application and high-frequency current application, the inverter controlling unit 10 may be operated such that direct current and high-frequency current flow at the same time, which enables current application that achieves both of a large heating amount, which is an advantage cf the direct current application described above, and a small loss, which is an advantage cf the high-frequency current application. In addition, when high-frequency current application is performed without using direct current application in the heating operation mode, a mechanism for switching connection of the wires of the motor may be provided so that the impedance is variable. In this case, the heating amount can be increased by lowering the impedance, and the voltage necessary for achieving heating is relatively increased by increasing the impedance, which widens the real vector width and enables control with high accuracy.

Note that, in the case of a motor having a high impedance, power that can be supplied by high-frequency current application is limited, which is more significant as the frequency is higher. Thus, in the heat pump device 100 according to the present embodiment, control to periodically change the carrier frequency in the heating operation mode is performed.

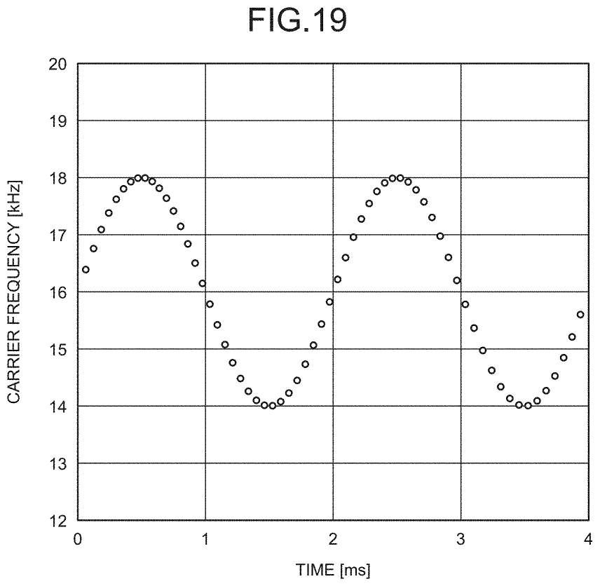

FIG. 19 is a graph illustrating an example of the control on the carrier frequency performed by the inverter controlling unity 10 of the heat pump device 100 according to the first embodiment. More specifically, FIG. 19 illustrates an example in a case where the center of the carrier frequency of the inverter 9 is 16 kHz, and the carrier frequency is changed. in a form of a sine wave with an amplitude of 2 kHz and a period of 1/500 s. In the example illustrated in FIG. 19, because the amplitude is 2 kHz, the carrier frequency periodically changes between 14 kHz and 18 kHz with a period of 1/500 s.

As illustrated in FIG. 19, the carrier frequency is controlled such that it periodically changes symmetrically with respect to the center value reference, and thus the average value of output power is close to that in the case of operation with the carrier frequency being constant at the central value (16 kHz), which enables control of the heating amount.

In addition, because the carrier frequency is made to be variable, the peaks of unwanted sound due to the carrier frequency can be dispersed, and the unwanted sound can be reduced. Thus, when the carrier frequency is changed with the center value of the carrier frequency being within an audible range (16 kHz or lower), it becomes possible to achieve both reduction in unwanted sound and increase in the heating amount.

While an example in which the carrier frequency is changed with an amplitude of 2 kHz and a period of 1/500 s is illustrated in FIG. 19, the carrier frequency is not limited thereto. Because the effect of dispersing carrier components cannot be sufficiently achieved when both the amplitude and the period are too small, it is more effective to have a relatively large amplitude and a relatively large period depending on the center value of the carrier frequency. The amplitude and the frequency are preferably set in view of the performance of a controller such as a CPU that implements the inverter controlling unit 10.

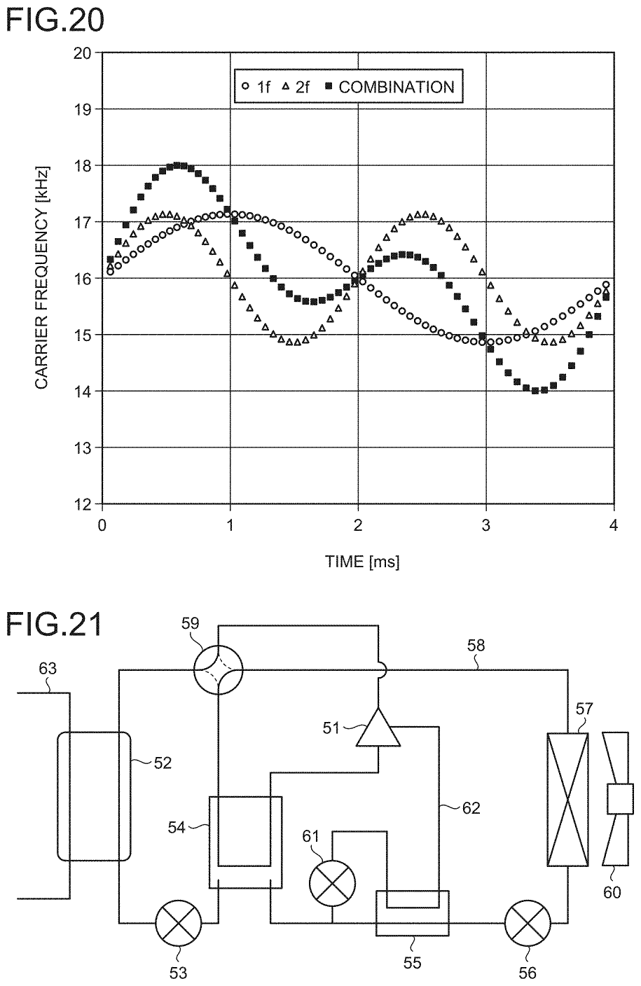

FIG. 20 is a graph illustrating another example of the control on the carrier frequency performed by the inverter controlling unit 10 of the heat pump device 100 according to the first embodiment. FIG. 20 illustrates an example of a case where the carrier frequency of the inverter 9 is changed with a combined period of a plurality of frequencies. More specifically, FIG. 20 illustrates an example of a case in which the carrier frequency, is changed with a combined period of two sine waves with the center frequency at 16 kHz, that is more specifically, in a form of a combined waveform of a first sine wave (1f) with a period of 1/250 s and a second sine wave (2f) with a period of 1/500 s. Because the amplitude of the combined waveform is 2 kHz, the carrier frequency changes periodically between 14 kHz and 18 kHz with a period of 1/250 s.

Note that the example illustrated in FIG. 20 is an example of a case where the first sine wave and the second sine wave have peak values equivalent to each other and phases overlapping at 0°. In addition, the amplitudes thereof are adjusted such that the peak value, that is, the amplitude of the combined waveform is 2 kHz.

As illustrated in FIG. 20, when the carrier frequency is controlled such that it changes at a combined frequency of sine waves with a plurality of frequencies, peaks of sound caused by the modulated frequency of the carrier frequency (beats caused by current peak pulses) can be dispersed, and the unwanted sound can be reduced.

In the sample illustrated in FIG. 20, the case where the carrier frequency is controlled to be a combined frequency of two frequencies having a relation of equivalent peak values and phases overlapping at 0° is illustrated, but the carrier frequency is not limited thereto. The peak values and the phases of two frequencies may be different from each other, and a larger number of frequencies may be combined. As the number of frequencies that are combined is larger, the unwanted sound peaks are more easily dispersed.

In addition, while the case where the carrier frequency is changed in a form of a sine wave is described in the present embodiment, the carrier frequency is not limited thereto, and may be changed in a shape such as a triangular wave, a saw-tooth wave, a trapezoidal wave, or a rectangular wave. Specifically, the effects can be produced when the carrier frequency has a periodicity that is point symmetry with respect to the carrier center value in a half-cycle, and a waveform changing continuously within one period is preferable among other waveforms. This is because peaks are less likely to arise when switchings of the carrier frequency close to each other concentrate within a short time period. Note that this is also applicable to the control as illustrated in FIG. 20, that is, a case where the carrier frequency is controlled such that the shape expressing the change in the carrier frequency corresponds to a shape obtained by combining a plurality of periodic waveforms with different frequencies.

In addition, when the carrier frequency is controlled as described in the present embodiment, noise can be dispersed, and the effect of reducing peaks can be produced. This peak reducing effect is likely to be significant when the modulation frequency of the carrier frequency is high (the period is short). This is because peaks are less likely to arise when switchings of the carrier frequency close to each other concentrate within a short time period.

Note that, changing the carrier frequency by using the periodicity thereof significantly facilitates selection of suitable parameters as compared with a method of making the carrier frequency variable by using combination of a plurality of given carrier frequencies.

In addition, although changing the frequency randomly can also produce the effect of reducing unwanted sound and noise, control of power is difficult in this case. In addition, there is a concern about generation of unexpected sound and noise caused by a current change due to a sudden change in the carrier frequency, which needs attention.

In addition, when the carrier frequency is changed every period instead of at peaks and valleys of the carrier signal, a difference in real vectors within a period can be reduced, and a breakage of an element caused by unexpected superimposition of direct currents and overheating can be reduced.

In addition, although computation may be performed each time the carrier frequency is changed, the arithmetic processing amount can be reduced by holding a table of the carrier frequency and reading a carrier frequency from the table depending on the phase information of the period. In addition, the relation between the center value of the carrier frequency and the waveform expressing the shape of a change in the carrier frequency may be patterned in advance and used for control. In this case, one of a plurality of patterns that were prepared in advance is read out, and control can be performed in accordance with the read pattern, which can further reduce the arithmetic processing amount.

In addition, use of semiconductors made of silicon (Si) for the switching elements 91a to 91f included in the inverter 9 and the freewheeling diodes 92a to 92f connected in parallel with the switching elements 91a to 91f, respectively, is typically the mainstream at present. Alternatively, however, wide bandgap semiconductors made of silicon carbide (SiC), gallium nitride (GaN), or diamond may be used.

Switching elements and diode elements made of such wide bandgap semiconductors have high voltage endurance and high allowable current density. This enables reduction in size of switching elements and diode elements, and use of the switching elements and diode elements that are reduced in size enables reduction in size of semiconductor modules incorporating these elements.

In addition, switching elements and diode elements made of such wide bandgap semiconductors also have high heat resistance. Thus, radiating fins of a heat sink can be reduced in size, and a water cooler can be air-cooled, which enables further reduction in size of semiconductor modules.

Furthermore, switching elements and diode elements made of such wide bandgap semiconductors have low power loss. This enables the efficiency of the switching elements and the diode elements to be increased, and thus enables the efficiency of semiconductor modules to be increased.

In addition, because switching can be performed at high frequency, current with higher frequency can be caused to flow in the motor 8, and current flowing to the inverter 9 can be reduced by reduction in winding current due to increase in the winding impedance of the motor 8, which enables a more efficient heat pump device 100 to be achieved. Furthermore, because use of higher frequency is further facilitated, there are advantages in that a frequency exceeding the audio frequency can be easily set and that measures can be more easily taken against unwanted sound.

In addition, wide bandgap semiconductors have high switching speed, and the on/off width (duty) thereof can be controlled with high accuracy, which enables control of output voltage with high accuracy even in a case of a motor having a low impedance.

In addition, because power loss is also reduced in the direct current application, there are advantages not only in that heat generation is decreased, but also in that the heat resistance performance is high and breakage due to heat generation is less likely to occur even if a high current flows.

Although both of the switching elements and the diode elements are preferably formed of wide bandgap semiconductors, either of the elements may be formed of wide bandgap semiconductors, which can also produce the effects described in the embodiment.

Alternatively, use of metal-oxide-semiconductor field-effect transistors (MOSFETs) having a super junction structure known as efficient switching elements can also produce similar effects.

In addition, in a compressor having a scroll mechanism, high-pressure relief from a compression chamber is difficult. Thus, as compared with other types of compressors, liquid compression may result in excessive stress acting on a compression mechanism, and the compression mechanism is likely to be damaged. In the heat pump device 100 of the present embodiment, however, the compressor 1 can be efficiently heated, and stagnation of liquid refrigerant in the compressor 1 can be reduced. Thus, because liquid compression can be prevented, this is also effective in a case where a scroll compressor is used as the compressor 1.

Furthermore, in the case of high-frequency current application, heating equipment with a frequency exceeding 10 kHz and an output exceeding 50 W may be restricted by laws or regulations. Thus, the voltage command V* may be adjusted in advance so as not to exceed 50 W, or flowing current or voltage may be detected. and feedback control may be performed such that the output is equal to or smaller than 50 W.

While current application is switched between high-frequency, current application and direct current application in the present embodiment, only one of the methods may be performed.

### Second Embodiment

FIG. 21 is a diagram illustrating an example of a configuration of a second embodiment of a heat pump device according to the present invention. In the present embodiment, an example of a specific configuration and operation in a case where the heat pump device 100 described in the first embodiment is installed in an air conditioner, a heat pump water heater, a refrigerator, a refrigeration machine, or the like will be described.

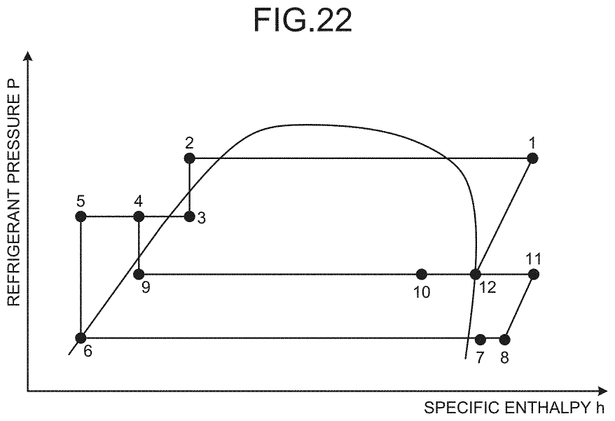

FIG. 22 is a Mollies diagram of the state of refrigerant in the heat pump device 100 illustrated in FIG. 21. In FIG. 22, the horizontal axis represents specific enthalpy, and the vertical axis represents refrigerant pressure.

The heat pump device 100 of The present embodiment includes a main refrigerant circuit 58 in which a compressor 51, a heat exchanger 52, an expansion mechanism 53, a receiver 54, an internal heat exchanger 55, an expansion mechanism 56, and a heat exchanger 57 are sequentially connected via pipes, and through which refrigerant circulates. Note that a four-way valve 59 is provided on a discharge side of the compressor 51 in the main refrigerant circuit 58, enabling switching of the circulating direction of the refrigerant. In addition, a fan 60 is provided near the heat exchanger 57. The compressor 51 corresponds to the compressor 1 described in the embodiment above, and is a compressor including the motor 8 driven by the inverter 9 and the compression mechanism 7.

Furthermore, the heat pump device 100 also includes an injection circuit 62 that connects from between the receiver 54 and the internal heat exchanger 55 to an injection pipe of the compressor 51 via pipes. The expansion mechanism 61 and the internal heat exchanger 55 are sequentially connected with the injection circuit 62. A water circuit 63 through which water circulates is connected with the heat exchanger 52. Note that a device that uses water, such as a water heater, a radiator, or a heat radiator for a floor heater or the like, is connected with the water circuit 63.

First, the operation of the heat pump device 100 of the present embodiment during heating operation will be described. During heating operation, the four-way valve 59 is set in the direction of the solid lines. Note that the heating operation includes not only heating used for air conditioning bur also hot water supply that heats water to make hot water.

Gas-phase refrigerant (point 1 in FIG. 22) that is increased in temperature and pressure in the compressor 51 is discharged from the compressor 51, subjected to heat exchange by the heat exchanger 52 that is a condenser and serves as a radiator, and thus liquefied (point 2 in FIG. 22). In this process, the water circulating through the water circuit 63 is heated by heat radiated from the refrigerant, and used for heating or hot water supply.

The liquid-phase refrigerant resulting from the liquefaction in the heat exchanger 52 is reduced in pressure by the expansion mechanism 53, and thus changed into a gas-liquid two-phase state (point 3 in FIG. 22). The refrigerant changed into the gas-liquid two-phase state by the expansion mechanism 53 is subjected to heat exchange at the receiver 54 with refrigerant sucked into the compressor 51, and thus cooled and liquefied (point 4 in FIG. 22). The liquid-phase refrigerant resulting from the liquefaction in the receiver 54 is divided into a flow through the main refrigerant circuit 58 and a flow through the injection circuit 62.

The liquid-phase refrigerant flowing through the main refrigerant circuit 58 is reduced in pressure by the expansion mechanism 61, and subjected to heat exchange at the internal heat exchanger 55 with the refrigerant changed into the gas-liquid two-phase state and flowing through the injection circuit 62, and thus cooled (point 5 in FIG. 22). The liquid-phase refrigerant resulting from the cooling in the internal heat exchanger 55 is reduced in pressure by the expansion mechanism 56, and thus changed into a gas-liquid two-phase state (point 6 in FIG. 22). The refrigerant changed into the gas-liquid two-phase state by the expansion mechanism 56 is subjected to heat exchange with outside air at the heat exchanger 57 that serves as an evaporator, and thus heated (point 7 in FIG. 22). The refrigerant heated by the heat exchanger 57 is then further heated at the receiver 54 (point 8 in FIG. 22), and sucked into the compressor 51.

Meanwhile, the refrigerant flowing through the injection circuit 62 is reduced in pressure by the expansion mechanism 61 (point 9 in FIG. 22), and subjected to heat exchange at the internal heat exchanger 55 (point 10 in FIG. 22) as described above. The refrigerant (injection refrigerant) in the gas-liquid two-phase state resulting from the heat exchange at the internal heat exchanger 55 flows in the gas-liquid two-phase state into the compressor 51 through the injection pipe of the compressor 51.

In the compressor 51, the refrigerant sucked from the main refrigerant circuit 58 (point 8 in FIG. 22) is compressed to an intermediate pressure and heated (point 11 in FIG. 22). The refrigerant compressed to the intermediate pressure and heated (point 11 in FIG. 22) is merged with the injection refrigerant (point 10 in FIG. 22), and is thus decreased in temperature (point 12 in FIG. 22). The refrigerant decreased in temperature (point 12 in FIG. 22) is then further compressed and heated to high temperature and high pressure, and discharged (point 1 in FIG. 22).

Note that, when the injection operation is not performed, the opening degree of the expansion mechanism 61 is set to fully closed. In other words, while the opening degree of the expansion mechanism 61 is larger than a predetermined opening degree when the injection operation is performed, the opening degree of the expansion mechanism 61 is set to be smaller than the predetermined opening degree when the injection operation is riot performed. The refrigerant thus does not flow into the injection pipe of the compressor 51.

Note that the opening degree of the expansion mechanism 61 is electronically controlled by a control unit such as a microcomputer.

Next, the operation of the heat pump device 100 during cooling operation will be described. During cooling operation, the four-way valve 59 is set in the direction of the broken lines. Note that the cooling operation includes not only cooling used for air conditioning but also removing heat from water to make cold water, refrigeration, and the like.

Gas-phase refrigerant (point 1 in FIG. 22) that is increased in temperature and pressure in the compressor 51 is discharged from the compressor 51, subjected to heat exchange by the heat exchanger 57 that is a condenser and serves as a radiator, and thus liquefied (point 2 in FIG. 22). The liquid-phase refrigerant resulting from the liquefaction in the heat exchanger 57 is reduced in pressure by the expansion mechanism 56, and thus changed into a gas-liquid two-phase state (point 3 in FIG. 22). The refrigerant changed into the gas-liquid two-phase state by the expansion mechanism 56 is subjected to heat exchange in the internal heat exchanger 55, and thus cooled and liquefied (point 4 in FIG. 22). In the internal heat exchanger 55, heat exchange is carried out between the refrigerant changed into the gas-liquid two-phase state by the expansion mechanism 56 and the refrigerant changed into the gas-liquid two-phase state (point 9 in FIG. 22) resulting from the reduction in pressure, by the expansion mechanism 61, of the liquid-phase refrigerant resulting from the liquefaction in the internal heat exchanger 55. The liquid-phase refrigerant (point 4 in FIG. 22) resulting from the heat exchange in the internal heat exchanger 55 is divided into a flow through the main refrigerant circuit 58 and a flow through the injection circuit 62.

The liquid-phase refrigerant flowing through the main refrigerant circuit 58 is subjected to heat exchange at the receiver 54 with the refrigerant sucked into the compressor 51, and thus further cooled (point 5 in FIG. 22). The liquid-phase refrigerant resulting from the cooling in the receiver 54 is reduced in pressure by the expansion mechanism 53, and thus changed into the gas-liquid two-phase state (point 6 in FIG. 22). The refrigerant changed into the gas-liquid two-phase state by the expansion mechanism 53 is subjected to heat exchange at the heat exchanger 52 that serves as an evaporator, and is thus heated (point 7 in FIG. 22). In this process, the refrigerant absorbs heat to cool the water circulating through the water circuit 63, which is used for cooling or refrigeration. As described above, the heat pump device 100 according to the present embodiment constitutes, together with a fluid using device that uses the water (fluid) circulating through the water circuit 63, a heat pump system, and the heat pump system can be used for an air conditioner, a heat pump water heater, a refrigerator, a refrigeration machine, or the like.

The refrigerant heated by the heat exchanger 52 is then further heated at the receiver 54 (point 8 in FIG. 22), and sucked into the compressor 51.

Meanwhile, the refrigerant flowing through the injection circuit 62 is reduced in pressure by the expansion mechanism 61 (point 9 in FIG. 22), and subjected to heat exchange at the internal heat exchanger 55 (point 10 in FIG. 22) as described above. The refrigerant (injection refrigerant) in the gas-liquid two-phase state resulting from the heat exchange in the internal heat exchanger 55 flows in the gas-liquid two-phase state into the compressor 51 through the injection pipe. The compressing operation in the compressor 51 is similar to that during heating operation.

Note that, when the injection operation is not performed, the opening degree of the expansion mechanism 61 is set to fully closed, so that the refrigerant does not flow into the injection pipe of the compressor 51, similarly to the heating operation.

In addition, in the description above, the heat exchanger 52 is explained as being such a heat exchanger as a plate type heat exchanger that provides heat exchange between the refrigerant and the water circulating through the water circuit 63. The heat exchanger 52 is not limited thereto, and may provide heat exchange between the refrigerant and air. In addition, the water circuit 63 may be a circuit through which another fluid circulates instead of the circuit through which water circulates.

As described above, the heat pump device 100 can be used for heat pump devices including an inverter compressor, such as an air conditioner, a heat pump water heater, a refrigerator, and a refrigeration machine.

The configurations presented in the embodiments above are examples of the present invention, and can be combined with other known technologies or can be partly omitted or modified without departing from the scope of the present invention.

### REFERENCE SIGNS LIST

1, 51 compressor; 2, 59 four-way valve; 3, 5, 52, 57 heat exchanger; 4, 53, 56, 61 expansion mechanism; refrigerant piping; 7 compression mechanism; 8 motor; 9 inverter; 10 inverter controlling unit; 11 normal operation mode controlling unit; 12 heating operation mode controlling unit; 13 driving signal generating unit; 14 heating determining unit; 15 direct current applying unit; high-frequency current applying unit; 17 heating command unit; 18 current application switching unit; 19 voltage command generating unit; 20 PWM signal generating unit; 21 temperature detecting unit; 22 stagnation amount estimating unit; 23 stagnation amount detecting unit; 24 stagnation determination switching unit; 25 heating necessity determining unit; 26 heating command computing unit; 27 current application switching determining snit; 28 direct-current voltage command computing unit; 29 direct-current phase command computing unit; 30 high-frequency voltage command computing unit; 31 high-frequency phase command computing unit; 32 high-frequency phase switching unit; 54 receiver; 55 internal heat exchanger; 58 main refrigerant circuit; 60 fan; 62 injection circuit; 63 water circuit; 91a to 91f switching element; 92a to 92f freewheeling diode; 100 heat pump device.

1. A heat pump device comprising:
a compressor to compress refrigerant;
a motor to drive the compressor;
an inverter to apply a desired voltage to the motor; and
an inverter controller to generate a pulse width modulation signal for driving the inverter, the inverter controller having, as operation modes, a heating operation mode for performing heating operation of the compressor and a normal operation mode for performing normal operation of the compressor to compress the refrigerant, the inverter controller periodically changing a carrier frequency symmetrically with respect to a center value reference in the heating operation mode, the carrier frequency being a frequency of a carrier signal.

2. The heat pump device according to claim 1, wherein the inverter controller changes the carrier frequency at a timing of either one of a peak and a valley of the carrier signal.

3. The heat pump device according to claim 1, wherein the inverter controller changes the carrier frequency in accordance with a combined waveform obtained by combining a plurality of periodic waveforms.

4. The heat pump device according to claim 1, wherein the inverter controller changes the carrier frequency in accordance with a combined waveform obtained by combining a plurality of waveforms with different periods.

5. The heat pump device according to claim 1, wherein the inverter controller holds a table including waveforms of a plurality of patterns registered therein, the patterns each representing a shape of a change of the carrier frequency, and changes the carrier frequency in accordance with a waveform registered in the table.

6. The heat pump device according to claim 1, wherein in the heating operation mode, the inverter controller generates a pulse width modulation signal by comparing a voltage command with a triangular wave carrier signal so as to apply a high-frequency alternating-current voltage at a frequency higher than an operation frequency in the normal operation mode to two phases or three phases of wires of the motor, and the voltage command alternately switches, at timings of a peak and a valley of a carrier signal, between voltage phases with phase differences of substantially 0° and substantially 180° from a reference phase of voltage applied to the motor.

7. The heat pump device according to claim 6, wherein in the heating operation mode, the inverter controller switches between high-frequency current application of applying a high-frequency alternating-current voltage to the wires of the motor and direct current application of applying direct current to the wires of the motor depending on a required heating amount.

8. The heat pump device according to claim 1, wherein switching elements included in the inverter are wide-gap semiconductors.

9. The heat pump device according to claim 1, wherein diodes included in the inverter are wide-gap semiconductors.

10. The heat pump device according to claim 8, wherein the wide-gap semiconductors are made of any of silicon carbide, a gallium nitride based material, and diamond.

11. The heat pump device according to claim 1, wherein switching elements included in the inverter are metal-oxide-semiconductor field-effect transistors having a super junction structure.

12. A heat pump system comprising: a heat pump device including a refrigerant circuit, the refrigerant circuit including a compressor including a compression mechanism to compress refrigerant, a first heat exchanger, an expansion mechanism, and a second heat exchanger sequentially connected via piping; and a fluid using device to use fluid subjected to heat exchange with the refrigerant by the first heat exchanger, the fluid using device being connected with the refrigerant circuit, wherein
the heat pump device includes:
the compressor to compress the refrigerant;
a motor to drive the compressor;
an inverter to apply a desired voltage to the motor; and
an inverter controller to generate a pulse width modulation signal for driving the inverter, the inverter controller having, as operation modes, a heating operation mode for performing heating operation of the compressor and a normal operation mode for performing normal operation of the compressor to compress the refrigerant, the inverter controller periodically changing carrier frequency symmetrically with respect to a center value reference in the heating operation mode, the carrier frequency being frequency of a carrier signal.

13. An air conditioner comprising a heat pump device according to claim 1.

14. A refrigeration machine comprising a heat pump device according to claim 1.

15. The heat pump device according to claim 9, wherein the wide-gap semiconductors are made of any of silicon carbide, a gallium nitride based material, and diamond.

16. An air conditioner comprising a heat pump device according to claim 12.

17. A refrigeration machine comprising a heat pump device according to claim 12.
